(19) United States
(12) Patent Application Publication
(10) Pub. No.: US 2020/0205608 A1
(43) Pub. Date: Jul. 2, 2020

(54) COOKING APPARATUS

(71) Applicant: Matthew Jared FENWICK, Ucluelet (CA)

(72) Inventor: Matthew Jared FENWICK, Ucluelet (CA)

(21) Appl. No.: 16/232,232

(22) Filed: Dec. 26, 2018

(51) Int. Cl. A47J 33/00

(52) U.S. Cl. CPC A47J 33/00

(57) ABSTRACT

A cooking apparatus has a first cord that has a first end removably attachable to a support structure and a second end that is connected to a locking tab. A second cord has a top end and a bottom end. The second cord passes through the locking tab such that the bottom end of the second cord is movable upwards and downwards and lockable in a desired vertical position. The bottom end is attached to a hang toggle for hanging a cooking vessel.

### FIELD OF THE DISCLOSURE

The present application relates generally to a cooking apparatus, more particularly it relates to a cooking apparatus for suspending a cooking vessel over a fire.

### BACKGROUND

This section provides background information to facilitate a better understanding of the various aspects of the invention. It should be understood that the statements in this section of this document are to be read in this light, and not as admissions of prior art.

It is common for people on camping excursions or other outdoor activities to cook their food over a fire. After the fire is built using available materials, food may be cooked. It is common to see metal grills or cookware suspended over the fire. It can be quite challenging to properly cook food over a fire as it is difficult to regulate heat. This can result in undercooked food, burnt food or extremely long cook times. One method used to regulate heat is to adjust the combustibles so as to grow of shrink the fire. This will increase or decrease the heat under the cookware. This method is slow to result in change to heat output and often requires someone skilled in the manipulation of the fire to create the appropriate temperature. Having a device that does not rely on the manipulation of fire could be beneficial to many people.

### BRIEF SUMMARY

There is provided a cooking apparatus for hanging a cooking vessel. A first cord is used for removable attachment to a support structure. A first end of the first cord is removably attachable to the support structure and a second end of the first cord is connected to a locking tab. A second cord passes through the locking tab and has a top end and a bottom end. The bottom end of the second cord is movable upwards and downwards as the second cord passes through the locking tab. Bottom end of the second cord is lockable in a desired vertical position. The bottom end is attached to a hang toggle for hanging a cooking vessel.

In one embodiment, the locking tab is a cam lock. When a cooking vessel is hung from the hang toggle, the weight of the cooking vessel is sufficient to cause the second cord to move the cam lock into a locking position.

In one embodiment, the top end of the second chord is attached to a handle. The handle provides a grip to allow for easier movement of second chord through the locking tab.

In one embodiment, the hang toggle has a first shoulder, a second shoulder and a bottom hook. The first shoulder and the second shoulder may be mirror images of each other or may have different dimensions.

In one embodiment, the first shoulder, the second shoulder and the bottom hook of the hang toggle may create a triangular shape.

In one embodiment, the hang toggle is sized such that it fits within the neck of a bottle with the first shoulder and the second shoulder of the hang toggle contacting the shoulders of a bottle to hang the bottle.

In one embodiment, the support structure is a tripod.

In another embodiment, the support structure is a tree branch.

In one embodiment, the second cord may be made of a non-flammable material. The first cord may also be made of a non-flammable material. The non-flammable material helps to prevent or limit damage to the first cord and second cord due to contact with a fire.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a side elevation view of the cooking apparatus supported by a tripod.

FIG. 2 is a side elevation view of the cooking apparatus shown in FIG. 1.

FIG. 3 is a side elevation view of a hang toggle.

FIG. 4 is a side elevation view of an alternative hang toggle.

FIG. 5 is a side elevation view of a hang toggle being inserted into the neck of a bottle.

FIG. 6 is a side elevation view of the hang toggle shown in FIG. 5 being used to suspend the bottle.

### DETAILED DESCRIPTION OF THE PREFERRED EMBODIMENTS

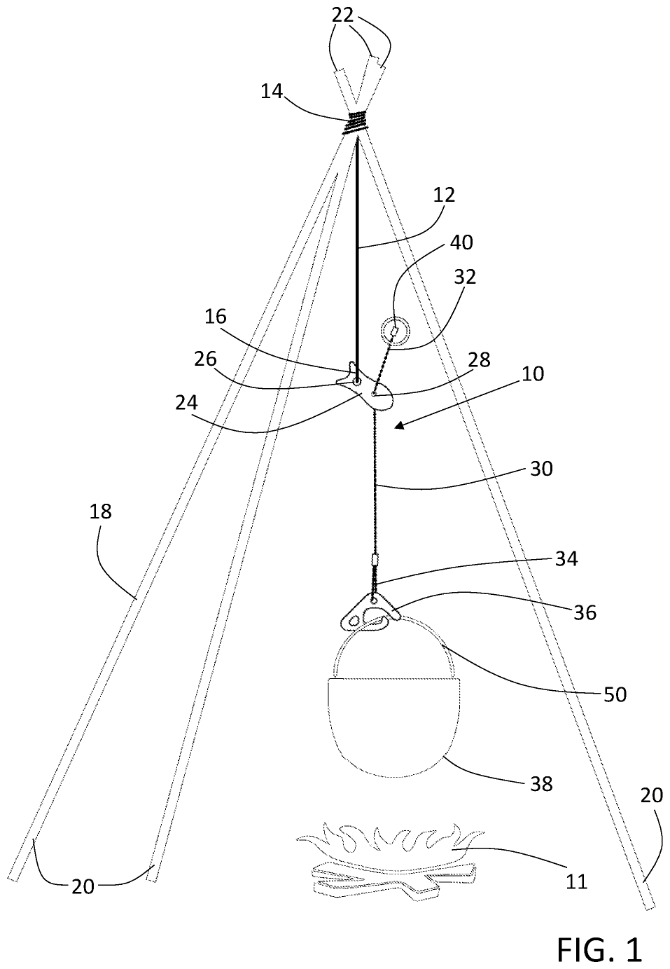

A cooking apparatus, generally identified by reference numeral 10, will now be described with reference to FIG. 1 through FIG. 6.

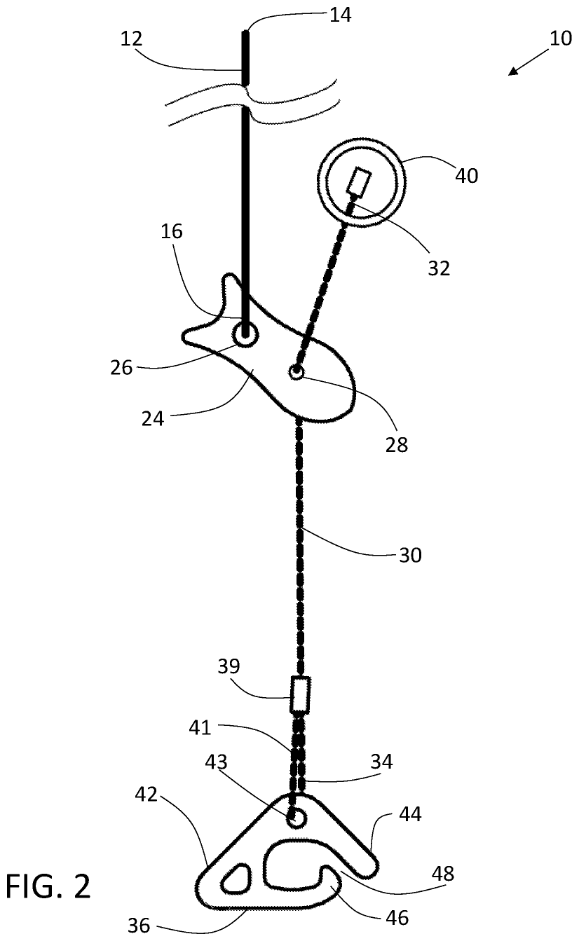

Referring to FIG. 1, cooking apparatus 10 has a first cord 12 that has a first end 14 and a second end 16. First end 14 of first cord 12 is removably attachable to a support structure 18. In the embodiment shown, support structure 18 is a tripod made from poles 20 and bound adjacent their top end 22 with first end 14 of first cord 12. It will be understood by a person skilled in the art that support structure may be made of any suitable material and any type of structure that allows for suspension of first cord 12. Tree branches may serve as a support structure in some instances or other conventional support structures may be used. Referring to FIG. 2, second end 16 of first cord 12 is connected to a locking tab 24. Second end 16 of first cord 12 may be tied directly to locking tab 24 through a connecting aperture 26 or may be attached through the use of an intermediary device such as a key ring, not shown. It will be understood by a person skilled in the art that any suitable means of connecting second end 16 of first cord 12 to locking tab 24 may be used. Locking tab 24 has a locking aperture 28 through which a second cord 30 may pass. Second cord 30 has a top end 32 and a bottom end 34. Second cord 30 passes through locking aperture 28 of locking tab 24 such that bottom end 34 of second cord 30 is movable upwards and downwards and lockable in a desired vertical position. Referring to FIG. 1, bottom end 34 of second cord 30 is attached to a hang toggle 36 for hanging a cooking vessel 38. This allows cooking vessel 38 to be raised away from a fire 11 when temperature within cooking vessel 38 becomes too great or lowered towards fire 11 when temperature within cooking vessel 38 is insufficient to cook the contents of cooking vessel 38. This allows the user to regulate the temperature of cooking vessel 38 without moderating fire 11. A benefit of utilizing hang toggle 36 is that cooking vessel 38 may be adjusted to any height along the length of second cord 30 and does not rely on fixed intervals which could prevent ideal positioning of cooking vessel 38. This allows for greater precision in temperature control. Referring to FIG. 2, in the embodiment shown, hang toggle 36 is attached to bottom end 34 of second cord 30 using a brass crimp 39 to create a loop 41 at bottom end 34 of second cord 30 that passes through a hanging aperture 43. A person of skill will understand that different methods of attaching bottom end 34 of second cord 30 to hang toggle 36 may be used.

Referring to FIG. 2, locking tab 24 has connecting aperture 26 and locking aperture 28. The distance between connecting aperture 26 and locking aperture 28 may vary depending upon a number of factors including the weight of cooking vessel 38 and its contents. It should be noted that connecting aperture 25 and locking aperture 28 are offset from the center of locking tab 24 to create more leverage from locking tab 24 when acting on second cord 30. In one embodiment, the distance between connecting aperture 26 and locking aperture 28 is 0.535 inches from center to center. The distance between connecting aperture 26 and locking aperture 28 may vary depending upon the size of locking tab 24 and the type of material that second cord 30 is made from. A distance between connecting aperture 26 and locking aperture 28 between 1 inch and 0.25 inches from center to center may be reasonable, however it will be understood that larger or smaller distances may also be used. If the distance between connecting aperture 26 and locking aperture 28 is too great, the extra leverage may magnify the load on second cord 30 and cause second cord 30 to kink making it more challenging or impossible to move second cord 30 through locking aperture 28. However, if the distance between connecting aperture 26 and locking aperture 28 is too small, locking tab 24 may have difficulty locking onto second cord 30 and may slip unnecessarily when locking aperture 28 attempts to engage second cord 30. Connecting aperture 26 should have a diameter large enough to freely pass first cord 12 or an intermediary connection through it. The size of locking aperture 28 is dependent upon the diameter of second cord 30. Second cord 30 should pass freely through locking aperture 28 yet grip firmly when the load of cooking vessel 38 is transferred to first cord 12. It will be understood by a person skilled in the art that other variations of locking tab 24 may be used, including but not limited to cam locks and other devices known in the art.

When choosing a material for first cord 12 and second cord 30, consideration should be given for the purposes of each. Since locking tab 24 acts as a lever on second cord 30, resistance to kinking may be important for the longevity of second cord 30. Utilizing a material that is capable of kinking may provide for greater locking within locking aperture 28 but may also limit the longevity of second cord 30 and cause undue fatigue. In a preferred embodiment, second cord 30 is a wire rope. When a wire rope is used, a wire rope with few and thick strands may improve kink resistance and provide for a stiffer rope. However, coiling of first cord 12 and second cord 30 for storage makes it easier to transport cooking apparatus 10. If first cord 12 and/or second cord 30 is too stiff, coiling diameter will increase or may induce premature metal fatigue. Premature metal fatigue may be avoided by storing first cord 12 and second cord 30 within cooking vessel 38 with a minimum diameter of 6.5 inches. A larger minimum diameter may be required depending upon the material from which first cord 12 and second cord 30 are made from. It may be beneficial for first cord 12 and second cord 30 to be made of non-flammable materials since cooking apparatus 10 is used in conjunction with a fire. It will be understood that first cord 12 and second cord 30 may be made of the same or different materials. In one embodiment, first cord 12 is a ⅛ inch diameter nylon cord.

Referring to FIG. 2, top end 32 of second cord 30 is attached to a handle 40. Handle 40 makes it more convenient for a user to grip top end 32 of second cord 30 when raising or lowering cooking vessel 38. A user may need to hold locking tab 24 when utilizing handle 40 to unlock second cord 30 from within locking aperture 28. Care should be taken when handling handle 40 and locking tab 24 when cooking apparatus 10 is in use as these elements may be hot to the touch.

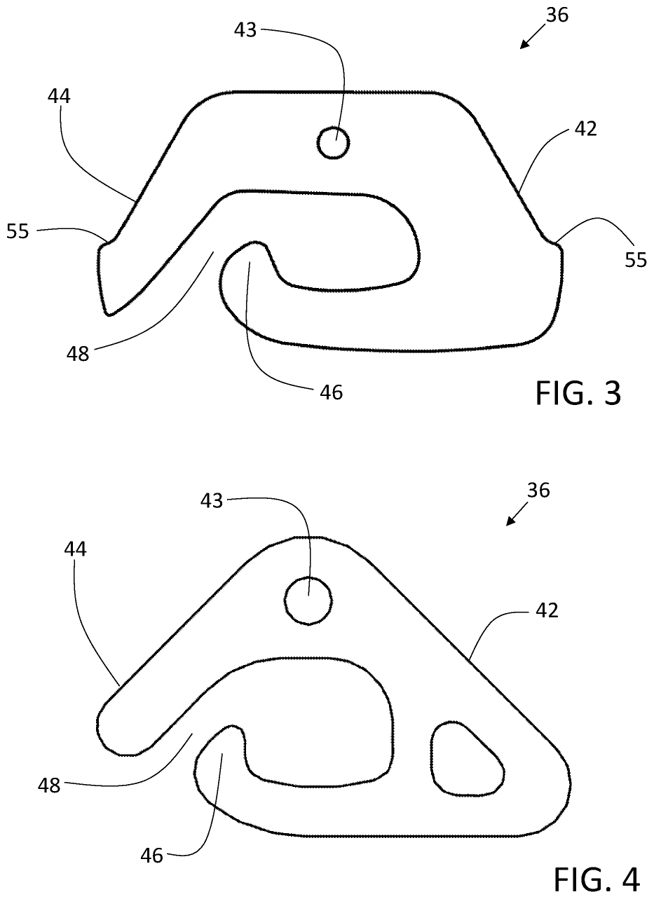

Referring to FIG. 3 and FIG. 4, hang toggle 36 has a first shoulder 42, a second shoulder 44 and a bottom hook 46. In both of the embodiments shown, bottom hook 46 hooks upwards towards first shoulder 42 and hang toggle has a mouth 48 to allow access to bottom hook 46. This allows hang toggle 36 to remain more compact. In the embodiments shown, first shoulder 42 and second shoulder 44 are mirror images of each other, however it will be understood by a person skilled in the art that first shoulder 42 and second shoulder 44 may be different from each other. Referring to FIG. 4, first shoulder 42, second shoulder 44 and bottom hook 46 may form a triangular shape. A triangular arrangement of first shoulder 42, second shoulder 44 and bottom hook 46 can provide improved stability of hang toggle 36. Referring to FIG. 3, to provide greater stability of hang toggle 36 within neck 52 of bottle 54, projections 55 may be provided to prevent hang toggle 36 from popping out of neck 52 when bottle 54 is jostled.

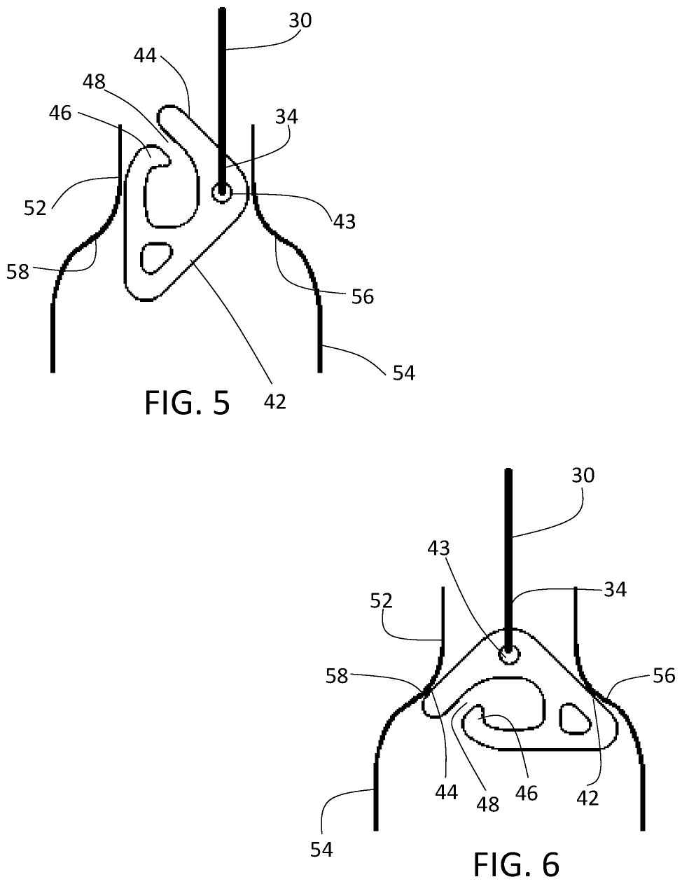

In the embodiment shown in FIG. 1, a handle 50 of cooking vessel 38 is hung on bottom hook 46. Bottom hook 46 is capable of holding handles of various cross sections, including but not limited to handles made from flat bail and round bail stock. Referring to FIG. 5 and FIG. 6, hang toggle 36 may be sized such that it fits within a neck 52 of a bottle 54. Referring to FIG. 5, when hang toggle 36 is rotated 90 degrees, it may be slid down neck 52 into the interior of bottle 54. Referring to FIG. 6, once hang toggle 36 is in the interior of bottle 54, it will swing back to its normal orientation. First shoulder 42 of hang toggle 36 will contact a first shoulder 56 of bottle 54. Second shoulder 44 of hang toggle 36 contacts second shoulder 58 of bottle 54. When both first shoulder 56 and second shoulder 58 of bottle 54 are contacted, it is possible to hang bottle 54 without the use of a handle. In order for hang toggle 36 to suspend bottle 54 by first shoulder 56 and second shoulder 58, the height of hang toggle 36 must be narrower than the diameter of neck 52 to allow insertion. Hang toggle 36 should also have a length that is wider than neck 52 such that first shoulder 42 and second shoulder 44 of hang toggle 36 contact first shoulder 56 and second shoulder 48, respectively, of bottle 54. If the two points in contact with bottle 52 are lower than hanging aperture 43, it acts as a wedge to prevent side to side movement and reduce the likelihood that hang toggle 36 comes dislodged from bottle 54.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its nonlimiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while failing within the scope of the invention. As such, the scope of the following claims should not be limited by the preferred embodiments set forth in the examples and drawings described above, but should be given the broadest interpretation consistent with the description as a whole.

What is claimed is:

1. A cooking apparatus comprising:
a first cord having a first end and a second end, the first end being removably attachable to a support structure, the second end being connected to a locking tab;
a second cord having a top end and a bottom end, the second cord passing through the locking tab such that the bottom end of the second cord is movable upwards and downwards and lockable in a desired vertical position, the bottom end being attached to a hang toggle for hanging a cooking vessel.

2. The cooking apparatus of claim 1 wherein the locking tab is a cam lock.

3. The cooking apparatus of claim 1 wherein the top end of the second cord is attached to a handle.

4. The cooking apparatus of claim 1 wherein the hang toggle has a first shoulder, a second shoulder and a bottom hook.

5. The cooking apparatus of claim 4 wherein the first shoulder and the second shoulder are mirror images of each other.

6. The cooking apparatus of claim 4 wherein the first shoulder, the second shoulder and the bottom hook of the hang toggle create a triangular shape.

7. The cooking apparatus of claim 4 wherein the hang toggle is sized such that it fits within the neck of a bottle and the first shoulder and the second shoulder of the hang toggle contact the shoulders of a bottle to hang the bottle.

8. The cooking apparatus of claim 1 wherein the support structure is a tripod.

9. The cooking apparatus of claim 1 wherein the support structure is a tree branch.

10. The cooking apparatus of claim 1 wherein the second cord is made of a non-flammable material.

11. The cooking apparatus of claim 1 wherein the first cord is made of a non-flammable material.
